(19) United States
(12) Patent Application Publication
(10) Pub. No.: US 2001/0005082 A1
(43) Pub. Date: Jun. 28, 2001

(54) Automobile door handle comprising sophisticated means for actuating switching devices

(76) Inventor: Bogdan Suparschi, Troy, MI (US)

Correspondence Address: Longacre & White, Suite 240, 6550 Rock Spring Drive, Bethesda, MD, 20817, US

(21) Appl. No.: 09/742,334

(22) Filed: Dec. 22, 2000

(30) Foreign Application Priority Data
Dec. 23, 1999 (FR) 9916343

(51) Int. Cl. E05B 1/00

(52) U.S. Cl. 292/347

(57) ABSTRACT

The invention proposes a handle for an automobile door comprising a cam (38) and an actuation lever (44) that are connected in rotation and installed free to pivot around an axis (A2) of the handle support (14) parallel to the axis (A1) of the operating lever (16), and in that the operating lever (16) comprises a drive pin (24) that cooperates with a control surface (42) of the cam (38), such that in the unlocking query position, the actuation lever (44) actuates the unlocking, switching device (34), and in the locking query position the actuation lever (44) actuates the locking switching device (36).

The invention relates to a handle for an automobile door.

The invention concerns particularly a handle for an automobile door of the type comprising an operating lever installed hinged around an axis parallel to the door, on a fixed handle support, pivoting outwards from its rest position into an unlocking query position in which it actuates a switching device controlling an unlocking query, and inwards into a locking query position in which it actuates a switching device controlling a locking query.

More particularly, the invention is applied as part of a security system for cars in which the door lock is locked and unlocked under the control of a central theftproof system, which makes a remote query to an identification batch worn by the user in order to enable unlocking or locking in this way.

For example, one such safety system is described in document EP-A0.218.251.

In the device described in this document, the user triggers the authentication or identification sequence when he manipulates the handle-gripping element. The gripping element then acts on an electric switch. This document describes how the user starts unlocking the lock when he pulls the gripping element outwards. To unlock the lock, the user pushes the gripping element inwards in order to engage a second switch.

In this type of design in which the mobile gripping element can be operated in two different directions to provoke two different actions, the gripping element may occupy an intermediate rest position and two opposite extreme positions in which it actuates either of the two switches.

The purpose of the invention is to propose a design for an automobile door opening handle that includes switching device actuation means that are more compact, more reliable and simpler than means used in existing actuation systems.

This is the purpose for which the invention proposes an automobile door handle of the type described above, characterized in that it comprises a cam and an actuation lever that are connected in rotation and installed free to pivot around a handle support axis parallel to the axis of the operating lever, and in that the operating lever comprises a drive pin that cooperates with a control surface of the cam, such that in the unlocking query position the actuation lever actuates the unlocking switching device, and in the locking query position the actuation lever actuates the locking switching device.

According to other characteristics of the invention:

the switching devices are mechanically actuated electrical switches;

the orientation of the drive pin is approximately axial;

the drive pin cooperates with the cam control surface through its external cylindrical surface;

the handle support comprises a housing fitted with a circuit support board fitted with a locking switch and an unlocking switch on one of its faces and on each side of the support axis, and the actuation lever comprises a locking arm facing the locking switch and an unlocking arm facing the unlocking switch;

the cam comprises a slot and the cam control surface is delimited by the parallel edges of the slot;

an actuation spring is inserted between the handle support and the unlocking arm of the actuation lever to permanently hold the unlocking arm in the direction in which the unlocking switch is actuated, and in the position in which the unlocking query is made, the drive pin releases the cam to enable the unlocking arm to actuate the unlocking switch under the action of the actuation spring;

the actuation spring is a compression spring that exerts pressure on the unlocking arm along a direction approximately tangential to the support axis;

the control surface of the cam comprises an unlocking bump and a locking bump, to provide the user with a feel to help him identify when the operating lever passes from the rest position to the unlocking query position, and from the rest position to the locking query position.

Other characteristics and advantages of the invention will become clear after reading the detailed description given below, which will be more easily understood with reference to the attached drawings in which:

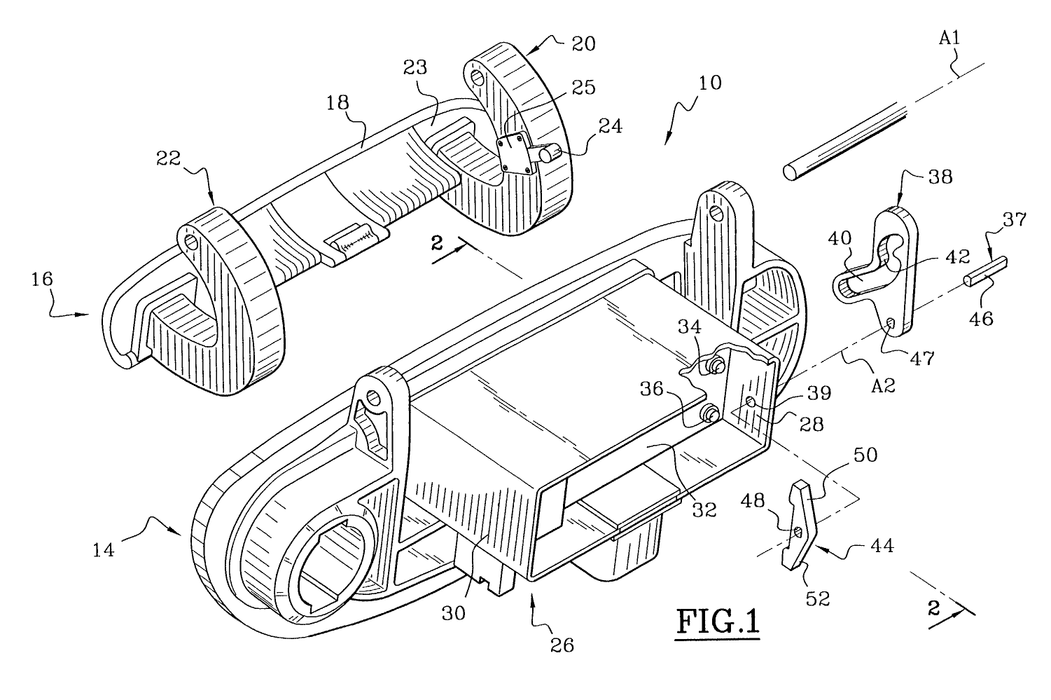

FIG. 1 is an exploded perspective view with a cutout showing a door handle made according to the information in the invention, according to a first embodiment;

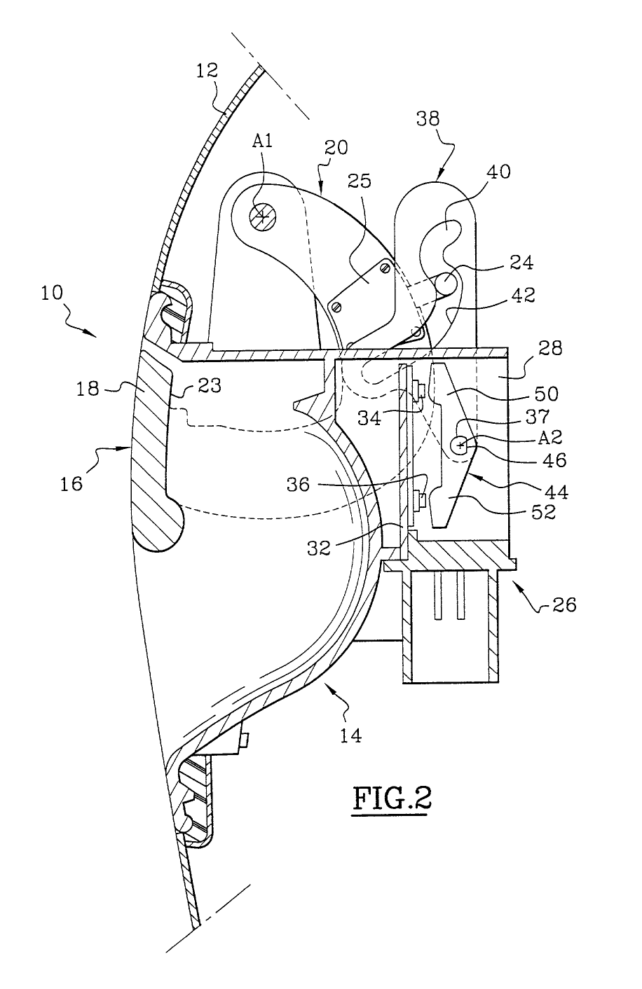

FIG. 2 is a sectional view that shows the door handle in FIG. 1 in the rest position;

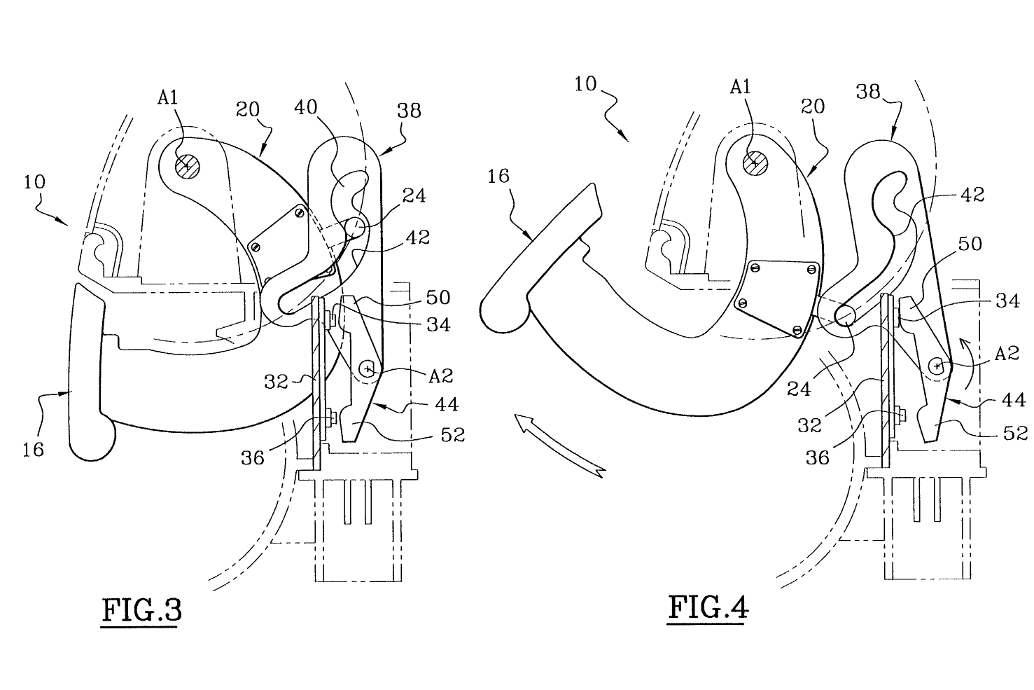

FIG. 3 is a diagrammatic view of a detail of FIG. 2 that illustrates the door handle in FIG. 1 in the rest position;

FIG. 4 is a view similar to the previous view illustrating the door handle in FIG. 1 in the unlocking query position;

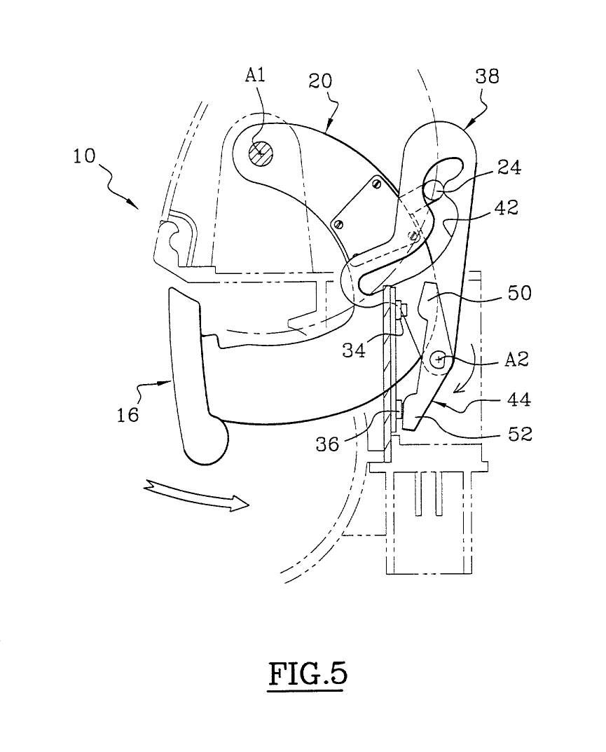

FIG. 5 is a view similar to FIG. 3 that illustrates the door handle in figure 1 in the locking query position;

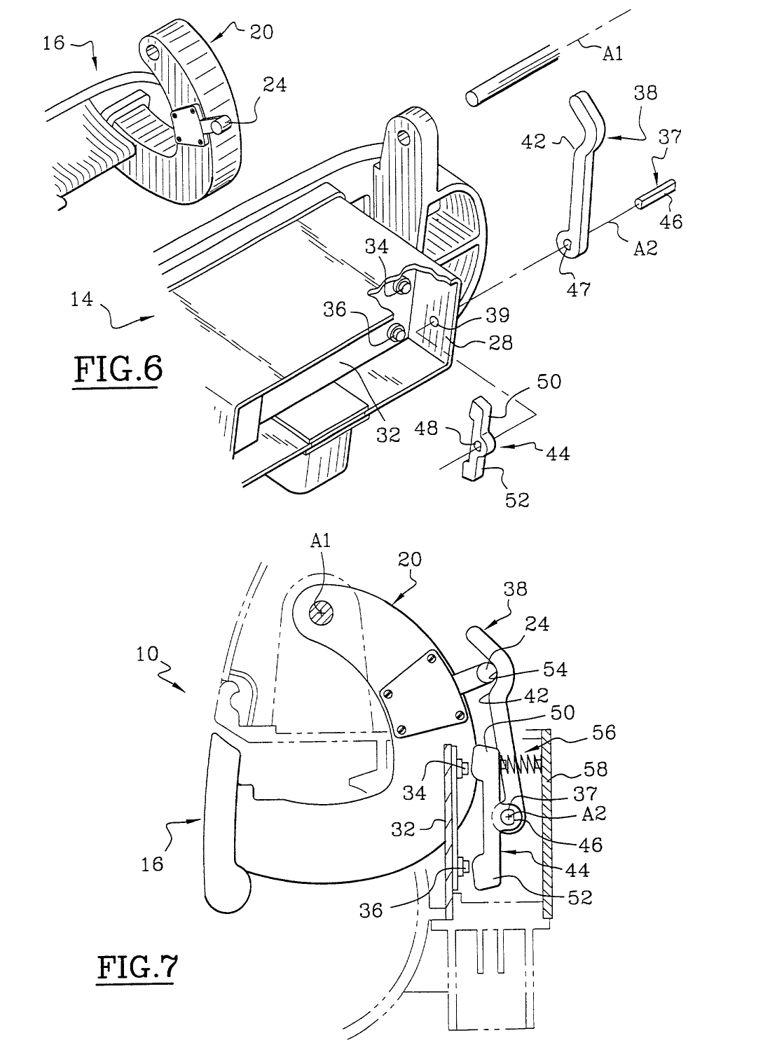

FIG. 6 is a view similar to FIG. 1 showing a partial view of a door handle made according to the information defined in the invention, according to a second embodiment;

FIG. 7 is a view similar to FIG. 3 that shows the door handle in FIG. 6 in the rest position;

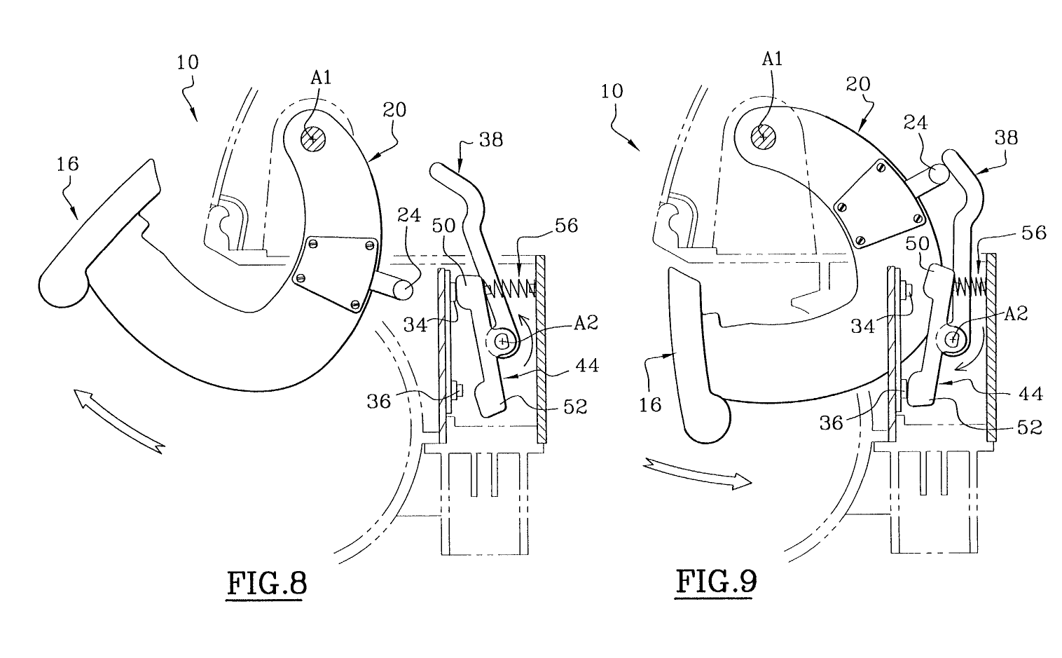

FIG. 8 is a view similar to the previous figure showing the door handle in FIG. 6 in the unlocking query position;

FIG. 9 is a view similar to FIG. 7 that shows the door handle in FIG. 6 in the locking query position.

In the following description, identical or similar components are denoted by the same reference figures.

For reasons of clarity, a top to bottom orientation will be used in a nonrestrictive manner corresponding to the orientation of the figures representing sectional views.

FIG. 1 shows an automobile door handle 10 made according to the information in the invention according to a first embodiment.

As can be seen in FIG. 2, the handle 10 is designed to be installed on an outside panel 12 of an automobile door, for example a side door of the vehicle.

In the following description, the left and right of the handle 10 will arbitrarily be defined to denote the left and right sides as seen looking at the handle from the outside.

The handle 10 comprises essentially a fixed support 14 for the handle that is designed to be installed in an opening in the outside panel 12, and an operating lever 16 that is installed hinged about the panel 12, around a geometric rotation axis A1, on support 14.

The geometric rotation axis A1 is approximately horizontal in this case, parallel to the general plane of the external panel 12 and is located in the upper part of the support 14.

The operating lever 16 is shown in FIG. 2 in the rest position Pr.

The operating lever 16 comprises a gripping plate 18 approximately parallel to the general plane of the external panel 12, and two vertical and parallel rotation arms 20, 22 that extend inwards from the inside surface 23 of the gripping plate 18, and which are globally in the shape of an arc of a circle curved upwards and outwards.

The free end of each rotating arm 20, 22 is free to rotate about the axis A1.

The operating lever 16 is free to pivot clockwise about axis A1 outwards from its rest position Pr into an unlocking query position Pd, and inwards in the anticlockwise direction from its rest position Pr, to a locking query position Pv.

Preferably, the operating lever 16 comprises elastic return means (not shown) that tend to bring it back from its unlocking query position Pd to its rest position Pr, and from its locking query position Pv to its rest position Pr.

One of the rotating arms 20, 22, in this case the left arm 20, comprises a drive pin 24 that extends towards the right parallel to axis A1.

In this case, the axial drive pin 24 is cast in a single piece with a plate 25 that is screwed onto the left rotating arm 20.

Obviously, the drive pin 24 may be fixed by any means on the left rotating arm 20. The drive pin 24 may also be cast in a single piece with the left rotating arm 20.

The fixed handle support 14 comprises a housing 26, approximately parallelepiped-shaped, with vertical sidewalls 28, 30 perpendicular to the general plane of panel 12 and therefore perpendicular to axis A1.

The housing 26 comprises a circuit support board 32 that is approximately parallel to the general plane of the panel 12 and which for example may be a printed circuit board.

The circuit support board 32 comprises an upper unlocking switch device 34 and a lower locking switch device 36 on its inner face, to make unlocking and locking queries respectively.

The switching devices 34, 36 are electrical switches with mechanical actuation.

A rod 37 is mounted free to rotate about a geometric rotation axis A2 parallel to the rotation axis A1 in a hole 39 that passes through the left sidewall of the housing 26.

In this case, the rod 37 is provided with a flat 46 and a cam 38 is mounted at the far left axial end of the rod 37 through an assembly hole 47 that is complementary to the cross-section of the rod 37, to fix the cam 38 in rotation with the rod 37.

Cam 38 is laid out on the left side, in other words on the outside, of the housing 26 between its left side wall 28 and the left rotating arm 20.

The cam 38 is fitted with a slot 40, the edges of which form the control surface 42 of the cam 38 with which the axial drive pin 24 cooperates along its external cylindrical surface.

An actuation lever 44 is installed at the far right axial end of the rod 37 through an assembly hole 48 complementary to the cross-section of the rod 37, such that the actuation lever 44 is fixed in rotation to the rod 37 and therefore to the cam 38.

The actuation lever 44 is placed at the right side, in other words inside the housing 26.

The actuation lever 44 comprises an upper unlocking arm 50 and a lower locking arm 52 on each side of the assembly hole 48.

In the rest position Pr, the actuation lever 44 is rotated approximately vertically such that the unlocking arm 50 is approximately facing the unlocking switch 34, and the locking arm 52 is approximately facing the locking switch 36.

We will now describe operation of the door handle 10 according to the first embodiment with reference to FIGS. 3 to 5 that represent the operating lever 16, in the rest position Pr, in the unlocking query position Pd and in the locking query position Pv respectively.

In the rest position Pr, the actuation lever 44 is oriented vertically and its unlocking arm 50 and its locking arm 52 are not in contact with the switches 34, 36.

The axial drive pin 24 is in an intermediate position in slot 40 in cam 38.

When changing from the rest position Pr to the unlocking query position Pd, the operating lever 16 pivots outwards about its rotation axis A1, in the clockwise rotation direction.

The axial drive pin 24 then pivots with the operating lever 16 towards the outside and cooperates with the control surface 42 of the cam 38, pivoting it about its axis A2, in the opposite direction of rotation, in this case the anticlockwise direction.

When it pivots in the same direction, the cam 38 also pivots the actuation lever 44, the unlocking arm 50 of which comes into contact with the unlocking switch 34 to actuate it.

Since the distance traveled by the operating lever 16 is high during unlocking, a control surface 42 of the cam 38 is provided that actuates the unlocking switch 34 in the first part of the travel distance of the operating lever 16 and that keeps the switch 34 pressed in throughout the rest of its travel distance.

Note that in the preferred embodiment of the invention, the control surface 42 of the cam 38 is designed such that, during the second part of the travel distance of the operating lever 16, the axial drive pin 24 does not pivot the cam 38 to prevent damaging elements of the mechanism by applying an excessive force on the unlocking arm 50 on the associated switch 34.

Conversely, when changing from the rest position Pr to the locking query position Pv, the operating lever 16 moves inwards about its rotation axis A1 in the anticlockwise direction.

The axial drive pin 24 then pivots inwards in the anticlockwise direction to cooperate with the control surface 42 of the cam 38 to make it pivot about its axis A2 in the reverse direction of rotation, in this case the clockwise direction.

Pivoting the cam 38 also pivots the actuation lever 44 in the same direction, and the unlocking arm 52 of the actuation lever comes into contact with the locking switch 36 to actuate it.

Note that the shape of the control surface 42 of the cam 38 is adapted to the travel distance of the operating lever 16 for locking and that this travel distance is usually shorter than the travel distance for unlocking.

Preferably, the control surface 42 of the cam 38 comprises an unlocking bump and a locking bump in order to give the user a feel enabling him to identify when the operating lever 16 passes from the rest position Pr to the unlocking query position Pv and from the rest position Pr to the locking query position Pv.

We will now describe a door handle made according to a second embodiment of the invention shown in FIGS. 6 to 9.

In the following, we will only describe elements that are different from the elements in the first embodiment.

The cam 38 is in the form of an arm that is approximately vertical and that is hinged at its lower end around a cam axis A2.

The control surface 42 of the cam 38 is formed on the face of the arm facing outwards.

The control surface 42 comprises a notch 54 into which the axial drive pin 24 fits in the rest position Pr as can be seen in FIG. 7.

The actuation lever 44 is similar to the lever in the first embodiment, and in particular is fixed to cam 38 in rotation.

However, a compression spring 56 is inserted between the unlocking arm 50 and a thrust plate 58 belonging to the housing 26.

The compression spring 56 continuously applies pressure to the unlocking arm 50 in the direction of actuation of the unlocking switch 34 and to the cam 38 tending to pivot it outwards.

However, the spring 56 is not sufficiently stiff to oppose return means (not shown) that hold the operating lever 16 in equilibrium in the rest position Pr.

We will now explain operation of the handle 10 according to the second embodiment.

In order to move from the rest position Pr to the unlocking query position Pd and from the rest position Pr to the locking query position Pv, the operating lever 16 moves in the same way as in the first embodiment.

When moving from the unlocking query position Pd, the axial drive pin 24 pivots outwards releasing the cam 38.

Under the action of the spring 56, the cam 38 also pivots outwards until the unlocking arm 50 actuates the unlocking switch 34. The entire cam 38 and the actuation lever 44 are then in the stop position in contact with the unlocking switch 34.

When moving from the locking query position Pv, the axial drive pin 24 pivots inwards pushing the cam 38 to force it into contact with spring 56, until the locking arm 52 actuates the locking switch.

According to one variant embodiment (not shown) of the invention, the rotation axis A1 of the operating lever 16 may be located in the lower part of the support 14 of the handle that inverts the direction of rotation of the operating lever 16 during the unlocking query and during the locking query.

1. Handle (10) for an automobile door of the type comprising an operating lever (16) installed hinged around an axis parallel to the door, on a fixed handle support (14), pivoting outwards from its rest position (Pr) into an unlocking query position (Pd) in which it actuates a switching device (34) controlling an unlocking query, and inwards into a locking query position (Pv) in which it actuates a switching device (36) controlling a locking query,
characterized in that it comprises a cam (38) and an actuation lever that are connected in rotation and installed free to pivot around an axis (A2) of the handle support (14) parallel to the rotation axis (A1) of the operating lever (16), and in that the operating lever (16) comprises a drive pin (24) that cooperates with a control surface (42) of the cam (38), such that in the unlocking query position (Pd), the actuation lever (44) actuates the unlocking switching device (34), and in the locking query position (Pv) the actuation lever (44) actuates the locking switching device (36).

2. Handle (10) according to the previous claim, characterized in that the switching devices (34, 36) are mechanically actuated electrical switches.

3. Handle (10) according to either of the previous claims, characterized in that the orientation of the drive pin (24) is approximately axial.

4. Handle (10) according to the previous claim, characterized in that the drive pin (24) cooperates with the control surface (42) of the cam (38) through its external cylindrical surface.

5. Handle (10) according to any one of the previous claims, characterized in that the handle support (14) comprises a housing (26) fitted with a circuit support board (32) fitted with a locking switch (36) and an unlocking switch (34) on one of its faces and on each side of the support (14) axis (A2), and the actuation lever (44) comprises a locking arm (52) facing the locking switch (36) and an unlocking arm (50) facing the unlocking switch (34).

6. Handle (10) according to any one of the previous claims, characterized in that the cam (38) comprises a slot (40) and the control surface (42) of the cam (38) is delimited by the parallel edges of the slot (40).

7. Handle (10) according to claim 5, characterized in that an actuation spring (56) is inserted between the handle support (14) and the unlocking arm (50) of the actuation lever (44) to permanently hold the unlocking arm (50) in the direction in which the unlocking switch (34) is actuated, and in that, in the position (Pd) in which the unlocking query is made, the drive pin (24) releases the cam (38) to enable the unlocking arm (52) to actuate the unlocking switch (34) under the action of the actuation spring (56).

8. Handle (10) according to the previous claim, characterized in that the actuation spring (56) is a compression spring that exerts pressure on the unlocking arm (50) along a direction approximately tangential to the axis (A2) of the support (14).

9. Handle (10) according to any one of the previous claims, characterized in that the control surface (42) of the cam (38) comprises an unlocking bump and a locking bump, to provide the user with a feel to help him identify when the handle passes from the rest position (Pr) to the unlocking query position (Pd), and from the rest position to the locking query position (Pv).
